(19) United States
(12) Patent Application Publication
(10) Pub. No.: US 2025/0173889 A1
(43) Pub. Date: May 29, 2025

(54) MAPPING OBJECTS IN A LOCAL AREA SURROUNDING A HEADSET TO A MODEL OF THE LOCAL AREA MAINTAINED BY THE HEADSET

(71) Applicant: Meta Platforms Technologies, LLC, Menlo Park, CA (US)

(72) Inventor: Tomislav Pejsa, San Jose, CA (US)

(21) Appl. No.: 18/522,701

(22) Filed: Nov. 29, 2023

(51) Int. Cl. G06T 7/70; G02B 27/01; G06T 7/50; G06V 10/25

(52) U.S. Cl. CPC G06T 7/70; G02B 27/017; G06T 7/50; G06V 10/25

(57) ABSTRACT

A headset, such as an artificial reality headset, includes a depth camera assembly that generates a three-dimensional model of a local area surrounding the headset. Additionally, the headset identifies objects in the local area through application of one or more trained models to images of the local area captured by imaging devices. The headset uses a bounding box determined for an identified object to map the identified object to the three-dimensional model of the local area. Based on the mapping, the headset may guide the user to the identified object or display content proximate to the identified object through a display element.

### FIELD OF THE INVENTION

This disclosure relates generally to artificial reality systems, and more specifically to object detection within a local area for artificial reality systems.

### BACKGROUND

Various devices, such as augmented reality (AR) headsets, implement one or more computer vision methods to detect or to recognize objects included in images. For example, an AR headset includes imaging devices capturing images of a local area around the AR headset, from which one or more objects are detected. Object recognition from the local area may be at a category level, where objects from a specific set of categories are detected, or at an instance level, where specific objects are detected from the local area based on training from a set of example images of a specific object. One or more object registration methods are used to train a device, such as an AR headset, to recognize specific objects.

Conventional methods for detection of objects in a local area use two-dimensional images of the local area from imaging devices, such as imaging devices on the headset. However, identifying one or more objects from two-dimensional images does not locate an object in the three-dimensional local area surrounding the headset. Without determining the three-dimensional location of an object in the local area relative to the headset, the headset cannot direct the user to the location in the local area surrounding the headset.

Additionally, many conventional computer vision methods for object detection treat each received image of the local area as independent from other received images of the local area. This independent identification of an object in each image prevents many conventional object detection methods from determining whether an image includes a new object or includes a different perspective of an object detected in one or more previously received images. Independently detecting objects in different images prevents conventional object detection methods from tracking or from identifying a specific object in different images of the local area.

### SUMMARY

Devices, such as augmented reality (AR) headsets, detect objects in a local area surrounding a device. In various embodiments, imaging devices capture images of the local area from which one or more objects are detected. As the images of the local area are two-dimensional, detection of objects from images of the local area allows identification of the object, but does not determine a position relative to a device, such as a headset, in the local area.

To augment detection of an object in the local area with a position of the object in the local area relative to the headset, the headset determines a local area model that is a three-dimensional representation of the local area surrounding the headset from depth information obtained by one or more depth sensors. For example, a headset includes one or more depth sensors that determine distances from the headset to portions of the local area surrounding the headset. From the depth information, the headset determines the local area model, which represents distances from the headset to different portions in the local area. From location and/or dimensions of a detected object in a captured image of the local area and parameters of an imaging device capturing the image, the headset determines a position and/or bounding box of the object within the local area model. By storing the position of the object in the local area model, display elements of the headset may display interface elements with positions determined based on the position of the object in the local area model. Placing an interface element based on the position of the object in the local area model allows the interface element to be displayed proximate to the object, simplifying presentation of information about the object to the user. Moreover, the interface element aids in contextualizing the information presented by the headset.

In various embodiments one or more imaging devices included in a headset worn by a user capture one or more images of a local area surrounding the headset. One or more objects in the local area are detected from an image of the local are captured by an imaging device, and a bounding box is determined for the object. The bounding box specifies dimensions of a region of the image including the object. From depth information generated by one or more depth sensors included in the headset, a local area model of the local area is determined. The local area model is a three-dimensional reconstruction of the local area. Based on the bounding box for the object and one or more parameters of the imaging device, a position of the object in the local area model is determined and stored in association with information identifying the object.

In some embodiments, a headset comprises one or more display elements coupled to a frame, with each display element configured to generate image light presented to a user. One or more imaging devices coupled to the frame are configured to capture images of a local area surrounding the frame, while a depth camera assembly is configured to obtain depth information between the headset and portions of the local area. An object detection module includes a processor and a non-transitory computer readable storage medium having instructions encoded thereon that, when executed by the processor, cause the headset to detect an object in the local area from an image of the local area captured by an imaging device and to determine a bounding box for the object. The bounding box specifies dimensions of a region of the image including the object. When executed by the processor, the instructions further cause the processor to determine a local area model of the local area from the depth information obtained by the one or more depth sensors, with the local area model comprising a three-dimensional reconstruction of the local area. Additionally, execution of the instructions by the processor causes the processor to determine a position of the object in the local area model based on the bounding box for the object and one or more parameters of the imaging device and to store the position of the object in the local area in association with information identifying the object.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an object detection module included in a headset, in accordance with one or more embodiments.

FIG. 3 is a flowchart illustrating a method for determining a position of an object in a model of a local area surrounding a headset, in accordance with one or more embodiments.

FIG. 4 is a process flow diagram of a method for determining a position of an object in a model of a local area surrounding a headset, in accordance with one or more embodiments.

FIG. 5 is an example of a headset displaying an interface element based on a position of an object in a local area model of a local area surrounding the headset, in accordance with one or more embodiments.

FIG. 6 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Various devices, such as augmented reality (AR) headsets, implement one or more computer vision methods to detect objects included in images. When detecting objects, a headset applies one or more object detection models to images of a local area surrounding the headset. One or more imaging devices included in, or coupled to, the headset capture the images of the local area. While detecting objects from images of the local area allows the headset to detect objects within the local area, as the images are two-dimensional, detection of an object from an image provides limited information to the headset about a position of the object relative to the headset.

To determine a position of a detected object in the local area to the headset, one or more depth sensors included in the headset obtain depth information for the local area. The depth information identifies distances between the headset and different portions of the local area, providing information about distances between objects and the headset. From the depth information, the headset generates a local area model that is a three-dimensional reconstruction of the local area based on distances between the headset and portions of the local area.

For an object detected in the local area, the headset determines a position of the object in the local area model to determine a distance between the headset and the object. To determine the position of the object in the local area model, the headset determines a center of a bounding box for the object. In various embodiments, the bounding box is determined when the object is detected from an image, with dimensions of the bounding box determined from characteristics of a region of the image including the object. From the dimensions of the bounding box, the headset determines the center of the bounding box and generates a ray intersecting the center of the bounding box based on parameters of the imaging device, including a position and an orientation of the imaging device in the local area. A position in the local area model where the ray intersects is determined as the position in the local area model of the object, with dimensions of the object in the local area determined from parameters of the imaging device. Storing the position of the object in the local area model in association with information identifying the object allows the headset to subsequently locate the object in the local area model or to determine positions of one or more interface element relative to the position of the object in the local area model.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

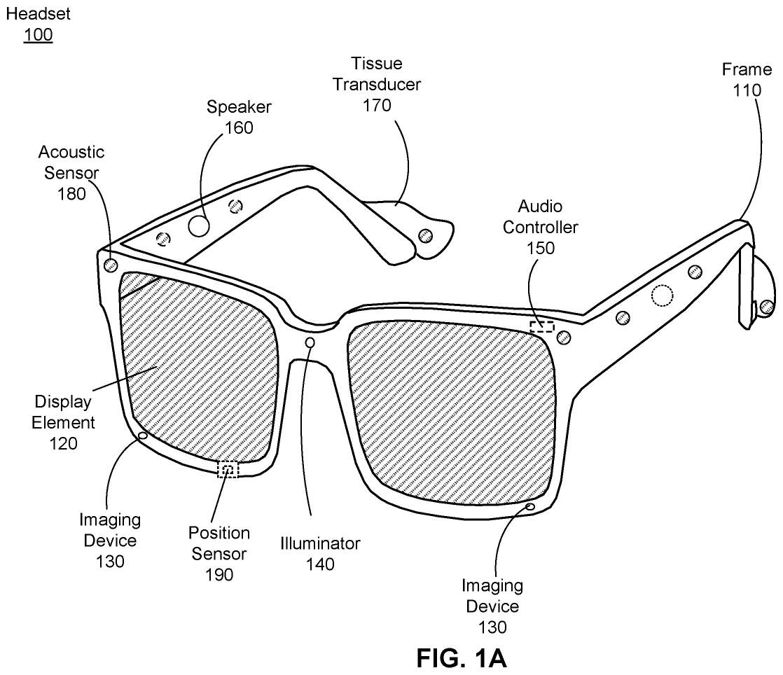

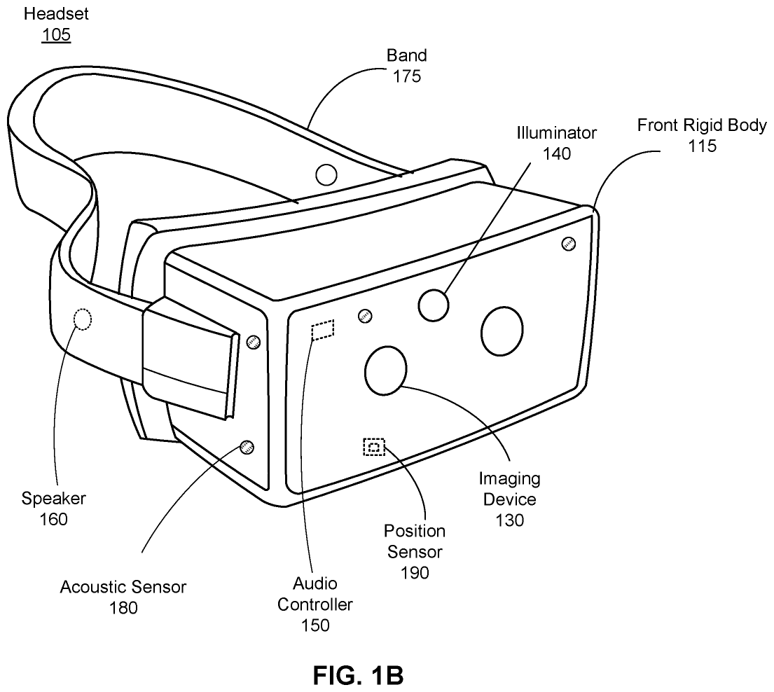

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The DCA may include an eye tracking unit that determines eye tracking information. The eye tracking information may comprise information about a position and an orientation of one or both eyes (within their respective eye-boxes). The eye tracking unit may include one or more cameras. The eye tracking unit estimates an angular orientation of one or both eyes based on images captures of one or both eyes by the one or more cameras. In some embodiments, the eye tracking unit may also include one or more illuminators that illuminate one or both eyes with an illumination pattern (e.g., structured light, glints, etc.). The eye tracking unit may use the illumination pattern in the captured images to determine the eye tracking information. The headset 100 may prompt the user to opt in to allow operation of the eye tracking unit. For example, by opting in the headset 100 may detect, store, images of the user's any or eye tracking information of the user.

From information about position and orientation or one or both eyes of a user, the eye tracking unit determines a direction of a user's gaze. For example, the eye tracking unit determines a vector or a ray representing fixation of the user's gaze relative to a position of the user's head. In various embodiments, the eye tracking unit determines fixation of the user's gaze of each eye of the user based on position and orientation of each of the user's eyes. The eye tracking unit may employ various models or combinations of models to determine the direction of the user's gaze from position and orientation information about one or more of the user's eyes in various embodiments, the audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

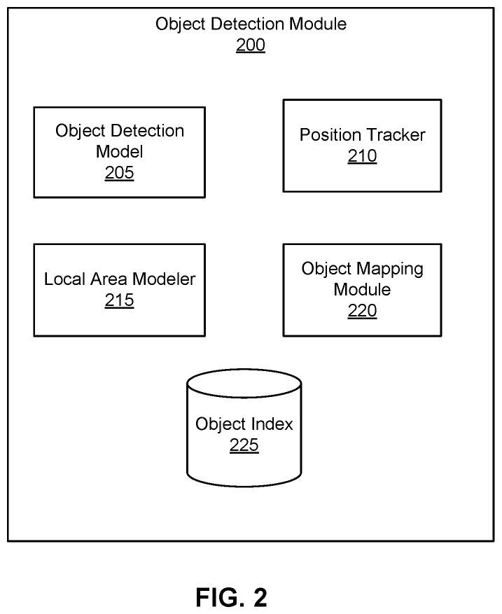

In various embodiments, the DCA is coupled to an object detection module, as further described below in conjunction with FIG. 2. The object detection model generates a local area model that is a three-dimensional reconstruction of a local area surrounding the headset 100 from depth information computed by the DCA. Hence, the local area model provides indications of distances between the headset 100 and various portions of the local area surrounding the headset 100. As further described below in conjunction with FIGS. 2-5, the object detection module also receives images of the local area from the one or more imaging devices 130 and detects objects within the local area from one or more captured images. For a detected object, the object detection module leverages the local area model to determine a position of the object in the local area model, allowing the headset 100 to both identify an object and determine a distance and orientation of the object relative to the headset 100. As further described below in conjunction with FIGS. 2-5, storing the position of the object in the local area model allows the headset 100 to subsequently locate the object or to account for the position of the object in the local area model when displaying one or more interface elements via a display element 120.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

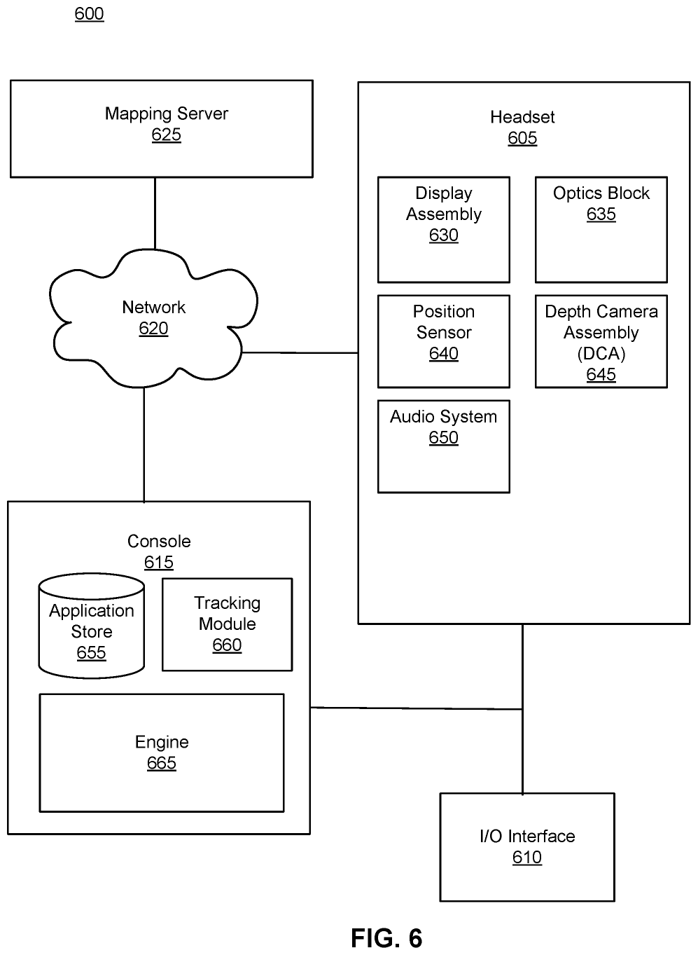

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 6.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

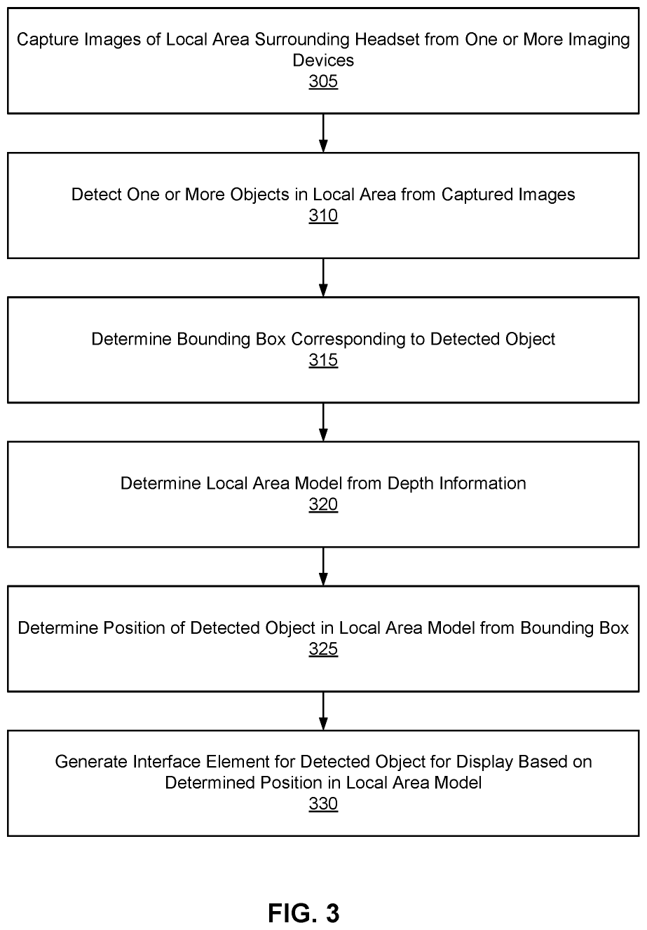

FIG. 2 is a block diagram of one embodiment of an object detection module 200. In various embodiments, the object detection module 200 is included in the headset 100. For example, the object detection module 200 is included in the frame 110 of a headset 100 or is coupled to the frame 110 of the headset 100. In other embodiments, the object detection module 200 is physically separate from the frame 110 of the headset 100 and is communicatively coupled to one or more components of the frame 110. For example, the object detection module 300 is included in a server or another computing device communicatively coupled to the frame 110 via a network or other communication channel. In the example of FIG. 3, the object detection module 200 includes an object detection model 205, a position tracker 210, a local area modeler 215, an object mapping module 220, and an object index 225. In other embodiments, the object detection module 200 includes additional, different, or fewer components than those described in conjunction with FIG. 2.

Further, the object detection module 200 includes a processor and one or more non-transitory computer readable storage media. The one or non-transitory computer-readable storage media have instructions encoded thereon that, when executed by the processor, cause the processor to provide the functionality further described below in conjunction with FIG. 2.

The object detection model 205 comprises one or more trained models that detect objects withing images of a local area surrounding a headset 100. For example, one or more imaging devices 130 capture images of the local area. In various embodiments, the imaging devices 130 are positioned on a frame of the headset 100, as further described above in conjunction with FIGS. 1A and 1B. For example, one or more imaging devices 130 have a field of view of the local area that at least partially overlaps with a field of view of the local area of a user wearing the headset 100.

In various embodiments, the object detection model 205 includes a category classifier. The category classifier is a trained model applied to images of the local area received from one or more imaging devices 130. In various embodiments, the category classifier is a trained region based convolutional neural network (R-CNN). Based on characteristics of different regions of an image of the local area, the category classifier identifies one or more categories, or types, of objects included in regions of the image. The category classifier does not identify a specific object from an image, but identifies regions of the image including an object having one or more categories, or types, for which the category classifier was trained. For example, the category classifier identifies regions in an image including an object having a category of “cup,” as a candidate object, but does not differentiate between different objects in the image having the category of “cup.” Hence, the category classifier identifies regions within an image of the local area likely to include an object having one or more categories of objects.

In various embodiments, the object detection model 205 alternatively or additionally includes an instance classifier. The instance classifier detects a specific object in images from the imaging devices 130. To detect a specific object, the specific object is initially registered with the instance classifier through a registration process initiated and performed by a user of the headset 100. The instance classifier detects the specific identified object rather than a category of objects, allowing the instance classifier to discriminate between different objects having a common category.

In some embodiments, the object detection model 205 includes a zero-short object detection model. The zero-short object detection model leverages an open-vocabulary object detector that detects objects in images based on free-text queries without needing to fine tune a model with labeled datasets. Open-vocabulary detection is achieved by embedding free-text queries with the text encoder and using them as input to the object classification and localization heads. The zero-shot instance-level object detection model can identify object instances (such as “blue pen”) without the user having to provide any prior training data for the specific instance. In one or more example implementations, the zero-shot object detection model could respond to the free-text queries to identify objects based on those queries. For example, in response to the question “Have you see my blue pen around here?”, the zero-shot instance-level object detection model may identify the specific pen queried without prior labeled training data of that specific pen.

In various embodiments, the instance classifier is a machine learning model comprising a set of weights. These weights are parameters used by the machine learning model to transform input data received by the model into output data. For the instance classifier, input data comprises one or more images of an object and an output is a label applied to the object, with the label identifying the object to the user. The weights may be generated through a training process, whereby the machine learning model is trained based on a set of training examples and labels associated with the training examples. In various embodiments, the training process includes: applying the machine learning model to a training example, comparing an output of the machine learning model to the label associated with the training example, and updating weights associated for the machine learning model through a back-propagation process. The weights may be stored on one or more computer-readable media to comprise the instance classifier. The training examples are images of the identified object captured by the one or more imaging devices 130. Subsequently, the instance classifier receives one or more images and detects the object in one or more images. Hence, the instance classifier allows a specific object to be detected in images, while the category classifier identifies a type or a category of an object included in one or more images. The object detection model 205 includes both a category classifier and an instance classifier in various embodiments.

For region in an image in which the object detection model 205 detects an object, the object detection model 205 also specifies dimensions for the object. In various embodiments, the object detection model 205 determines a bounding box for an object, with the object included in the region of an image enclosed in the bounding box. The object detection model 205 determines dimensions of a bounding box for each object based on characteristics of a region including the object, so different objects may be surrounded by bounding boxes having different dimensions. Additionally, the object detection model 205 determines dimensions of bounding boxes without user input in various embodiments, simplifying identification of objects in an image. In various embodiments, the object detection model 205 identifies coordinates within an image of bounding boxes for each object detected in the image and associates an object identifier with each bounding box to identify different objects. The object detection model 205 also associates a label with each detected object, with a label identifying a category corresponding to an object or an instance corresponding to the object, or a combination of a category corresponding to an object and an instance corresponding to the object.

While FIG. 2 shows an example where the object detection model 205 is included in the object detection module 200, in other embodiments, the object detection model 205 is included in a separate device than the object detection module 200. For example, the object detection module 200 is included in a frame 110 of a headset 100, while a server or another computing device that is communicatively coupled to headset 100 executes the object detection model 205. In the preceding example, the computing device executing the object detection module 205 receives images of the local area from one or more imaging devices 130 included in the headset 100 and transmits information identifying one or more objects detected in the one or more images to the headset 100.

The position tracker 210 obtains one or more measurement signals from one or more position sensors 190. One or more of the measurement signals are generated in response to motion of the headset 100. In some embodiments, one or more measurement signals are received from the depth camera assembly (DCA) of the headset 100 or from one or more other depth sensors included in the headset 100. From the one or more measurement signals, the position tracker 210 determines a position of the headset 100 in the local area surrounding the headset 100. When determining the position of the headset 100, the position tracker 210 determines a coordinate system for the local area surrounding the headset 100 and determines the position of the headset 100 in the coordinate system for the local area. In various embodiments, the position tracker 210 uses one or more simultaneous localization and mapping (SLAM) methods to determine the position and the orientation of the headset 100 in the local area in three dimensions.

In various embodiments, the position tracker 210 executes one or more methods to reduce errors in the determined position of the headset 100 in the local area over time. As a user moves within the local area while wearing the headset 100, previously determined positions of the headset 100 drift from corresponding features in the local area, such as corresponding objects in the local area. To compensate for such errors, the position tracker 210 caches features of the local area (e.g., reference locations or reference objects in the local area) and transforms for the user's head determined for specific positions in the local area at different times, with a transform representing the position and orientation of the headset 100 in the local area. The position tracker 210 matches reference locations or reference objects in captured images from the one or more imaging devices 130 and modifies a head transform for the user based on comparison of reference locations or reference object and the cached reference locations or reference objects. Modifying the transform for the user based on the comparison allows the position tracker 210 to reduce errors accumulated for the determined position of the headset 100 in the local area.

The local area modeler 215 receives data from the depth camera assembly (DCA) of the headset 100 and generates a local area model that is a three-dimensional representation of the local area surrounding the headset 100. From depth information from the DCA or from other depth sensors, the local area model includes information that coarsely identifies locations and shapes of objects in the local area. Different portions of the local area model have different distances from the headset 100 determined by the depth information, so the local area model provides a representation of distances between the headset 100 and different portions of the local area.

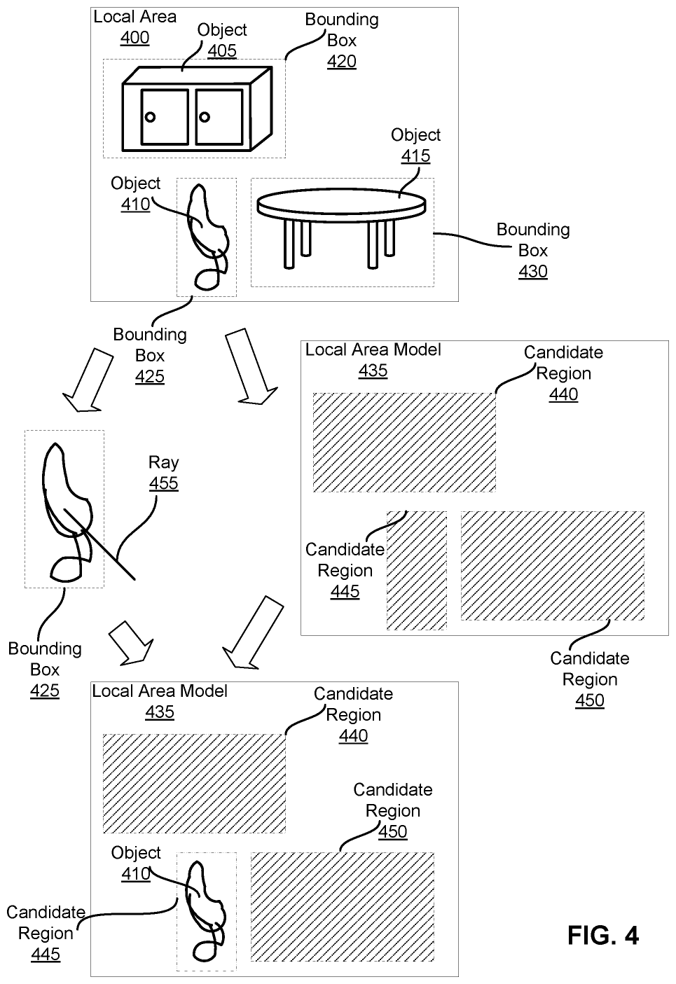

The object mapping module 220 identifies positions within the local area model for objects detected in the local area by the object detection model 205. The object mapping module 220 receives an image from an imaging device 130 of the headset 100 and a set of objects detected in the image by the object detection model 205. In various embodiments, each object of the set of objects detected in the image includes a corresponding bounding box and one or more labels (e.g., a category label, an instance label). The object mapping module 220 determines a position within the local area model for an object by determining a ray through the bounding box for the object and casting the ray against the local area model. The object mapping module 220 identifies a position of an object as a position in the local area model where intersected by the ray passing through the bounding box for the object, as further described below in conjunction with FIGS. 3 and 4. Additionally, based on dimensions of the bounding box for the object, the object mapping module 220 determines dimensions of the object in the local area model, as further described below in conjunction with FIGS. 3 and 4.

Based on the determined position of the object in the model of the local area, the object mapping module 220 determines a position of an interface element displayed proximate to the object by one or more display elements 120 of the headset 100. For example, the object mapping module 220 determines an offset between a boundary of an interface element and a portion of the bounding box for the object in the local area model and positions a portion of the interface element at the determined offset, so the interface element is displayed with the offset between the boundary of the interface element and the portion of the bounding box. Such placement allows display of the interface element proximate to the object that is visible in the local area to the user. In other embodiments, the interface elements may be displayed for other manners of interacting with detected objects. For example, if the user prompted the object detection module 200 to navigate the user to particular cached object, the interface elements may provide navigation guidance to the object's position, e.g., located in a different room.

In response to determining the position of an object in the local area model, the object mapping module 220 updates data stored in the object index 225 based on the determined position of the object. In various embodiments, the object mapping module 220 determines a position within the local area model of an object in conjunction with one or more labels for the object determined by the object detection model 205. For example, the object mapping module 220 determines coordinates in the local area model and associates the coordinates with one or more labels identifying a category or an instance of the object. The combination of coordinates and one or more labels is stored in the object index 225 to subsequently retrieve a position of the object in the local area.

The object index 225 includes previously determined combinations of coordinates of objects in the local area model that are each associated with one or more labels. In various embodiments, the object mapping module 220 updates a stored combination of coordinates of an object in the local area model corresponding to one or more labels. The object mapping module 220 compares the combination of coordinates within the local area model and one or more labels to stored combinations of coordinates within the local area model and one or more labels in the object index 225. In response to determining the combination of coordinates within the local area model and one or more labels does not match at least one combination of coordinates within the local area model and one or more labels in the object index 225, the object mapping module 220 stores the combination of coordinates within the local area model and one or more labels in the object index 225 to identify a newly detected object. In various embodiments, the object mapping module 220 determines whether the combination of coordinates within the local area model and one or more labels is within a threshold distance of a stored combination of coordinates within the local area model and one or more labels in the object index 225. In response to determining the combination of coordinates within the local area model and one or more labels is within a threshold distance of a stored combination of coordinates within the local area model and the one or more labels in the object index 225, the object mapping module 220 updates the stored combination of coordinates in the local area model and the one or more labels in the object index 225 to include the determined combination of coordinates in the local area model. This allows data stored in the object index 225 to be updated to reflect changes in position of an object within the local area model over time, allowing the object index 225 to maintain a current location within the local area model of an object.

In some embodiments, the object mapping module 220 may group objects together to form a single object. In such embodiments, the object mapping module 220 determines whether bounding boxes of the two objects sufficiently intersect and whether the two objects have the same label. If so, the object mapping module 220 may group the two objects into a single object. In other embodiments, the object mapping module 220 may group objects based on the intersection of the shapes (e.g., three-dimensional or two-dimensional) sufficiently intersect.

FIG. 3 is a flowchart of a method for a headset 100 determining position of an object in a model of a local area surrounding the headset 100, in accordance with one or more embodiments. The process shown in FIG. 3 may be performed by components of an object detection system (e.g., object detection module 200). Other entities may perform some or all of the steps in FIG. 3 in other embodiments. Embodiments may include different or additional steps, or perform the steps in different orders.

A headset 100, as further described above in conjunction with FIGS. 1A and 1B includes one or more imaging devices 130 capturing 305 images of a local area surrounding the headset 100. In various embodiments, the imaging devices 130 are positioned on a frame 110 so fields of view of the imaging devices 130 at least partially overlap with a field of view of the user wearing the headset 100. Such embodiments allow images captured 305 by the one or more imaging devices 130 to reflect the perspective of the local area from the user's eyes. The local area includes one or more objects, with the user capable of seeing the objects through the headset 100 in various embodiments.

To augment objects visible to the user in the local environment with additional information generated by the headset 100, or received by the headset 100, the headset 100 detects 310 one or more objects within one or more images of the local area captured 305 by the imaging device 130. As further described above in conjunction with FIG. 2, in various embodiments the headset 100 includes an object detection module 200 that applies one or more object detection models 205 to images of the local area from the imaging devices 130. The object detection model 205 identifies regions of an image of the local area including objects based on characteristics of different regions of the image. As further described above in conjunction with FIG. 2, an object detection model 205 may identify a category of an object within an image, may identify an instance of the object within the image, or may identify a combination of the category of an object and the instance of the object within the image in various embodiments.

When detecting 310 objects in an image, dimensions of each object are identified within an image where an object was detected. The object detection model 205 determines 315 a bounding box for an object to represent dimensions of a region of an image corresponding to the object. The region of an image corresponding to the object is enclosed in the bounding box to differentiate the object from other regions of the image. The object detection model 205 determines 315 dimensions of a bounding box based on characteristics of a region including the object, so different objects may be surrounded by bounding boxes with different dimensions. In various embodiments, dimensions of a bounding box for a region of an image including an object are determined 315 without user input. For example, the headset 100 identifies coordinates within an image of bounding boxes for each region of the image including an object detected in the image and associates an identifier with each detected object and corresponding bounding box. In various embodiments, one or more labels are associated with coordinates within an image of each bounding box. A label may identify a category of a detected object, an instance of a detected object, a combination of an instance and a category of the detected object, or other information describing or identifying a detected object. Alternatively or additionally, an object identifier is associated with a bounding box to differentiate the bounding box and corresponding object from other objects in the image.

One or more depth sensors, such as a depth camera assembly (DCA), included in the headset 100 capture measurement signals describing the local area, the measurement signals include depth information that identifies distances between portions (e.g., object) of the local area and the headset 100. From the depth information in one or more measurement signals, the headset 100 determines 320 its position within the local area. In various embodiments, the headset 100 determines a coordinate system for the local area surrounding the headset 100 from the measurement signals and determines 315 the position of the headset 100 in the coordinate system for the local area. For example, the headset 100 uses one or more simultaneous localization and mapping (SLAM) methods to determine the position of the headset 100 within a coordinate system for the local area. As further described above in conjunction with FIG. 2, in various embodiments, the headset 100 executes one or more methods to reduce errors in the determined position of the headset 100 in the local area over time.

From the measurement signals and the position of the headset 100 in the local area, the headset 100 determines 320 a local area model of the local area surrounding the headset 100. The local area model is a three-dimensional representation of the local area surrounding the headset 100. Different portions of the local area model correspond to portions of the local area having different distances to the headset 100.

In various embodiments, the local area model includes candidate regions corresponding to potential locations of objects in the local area, with the candidate regions determined from depth information. For example, a candidate region corresponds to a region in the local area including having depth information differing from depth information for an adjacent region in the local area by at least a threshold amount. In the preceding examples, differences in depth information between different regions of the local area determine boundaries of candidate regions in the local area model. Identifying candidate regions within the local area model allows the headset 100 to leverage depth information from the local area to identify potential regions in the local area model for one or more objects.

For an object detected 310 in an image of the local area, the headset 100 determines 325 a position of the object within the local area model based on the bounding box determined 315 for the object. In various embodiments, the headset 100 determines coordinates of the bounding box for the object in the captured image in which the object was detected 310. From the coordinates of the bounding box, the headset 100 determines a center of the bounding box through one or more methods. For example, the headset 100 determines the center of the bounding box based on a width and a height of the bounding box. The headset 100 additionally accounts for characteristics of an imaging device 130 that captured the image of the local area when determining the center of the bounding box for the object. For example, the headset, such as the object mapping module 220 of an object detection module 200, determines a height and a width of the imaging device 130 to account for a resolution of the imaging device 130 and modifies the determined center of the bounding box based on the height and the width of the camera, so dimensions of the bounding box used to determine its center account for parameters of the imaging device, such as a resolution or an aspect ratio of the imaging device 130.

With the center of the bounding box for the object determined, the headset 100, such as the object detection module 200, generates a ray that intersects the center of the bounding box in coordinates corresponding to the local area model. The ray is perpendicular to the bounding box and intersects the bounding box at the center of the bounding box in various embodiments. When determining the ray passing through the center of the bounding box, the headset 100 uses an imaging device transform based on the position and orientation of the imaging device 130 in the local area determined from the position sensors 190 of the headset and an imaging device projection transform determined from the imaging device transform (the position and orientation of the imaging device 130 in the local area) in combination with parameters of the imaging device 130 (e.g., focal length, pixel size, image origin, etc.). For example, the center of the bounding box for the region including the object is scaled based on the imaging device transform and the imaging device projection transform so the ray passing through the center of the bounding box is generated in coordinates corresponding to the local area model.

The headset 100 determines 325 the position of the object in the local area model as a position in the local area model where the ray intersecting the center of the bounding box for the object intersects the local area model. In various embodiments, the headset 100 determines 325 the position of the object in the local area model as a position of a candidate region included in the local area model in response to the ray from the center of the bounding box for the object intersecting at least a portion of the candidate region. The headset 100 may determine 325 the position of the object as a candidate region in response to the ray from the center of the bounding box for the object intersecting the local area model within a threshold distance of a candidate region in some embodiments. Further, in some embodiments, the headset 100 disregards the detected object in response to the ray from the center of the bunding box for the object intersecting the local area model greater than a threshold distance from a candidate region in the local area model. This allows the headset 100 to account for depth information of the local area to map the object to a portion of the local area model corresponding to a region of the local area having depth information that differs from depth information of adjacent regions of the local area.

In addition to determining the position in the local area model of the object, the headset 100 determines a distance from the headset 100 to the object. In various embodiments, the headset 100 scales a distance between the headset 100 and the object in the local area model by the imaging device transform to determine the distance between the headset 100 and the object in the local area model. As the imaging device transform is based on the position and orientation of the imaging device 130 in the local area, determining the distance between the headset 100 and the object based on the imaging device transform increases an accuracy of the distance determined between the headset 100 and the object by accounting for the position and orientation of the headset 100 in the local area.

Further, in some embodiments, the headset 100 determines a size of the object in the local area model. When determining the size of the object in the local area model, the headset 100 determines a size of the object in the image where the object was detected. In various embodiments, the headset 100 determines the size of the object in the image based on dimensions of the bounding box corresponding to the object. The headset 100 scales the determined size of the object in the image based on parameters of the imaging device 130 that captured the image and the image device projection transform to determine the size of the object in the local area model. For example, the headset 100 determines a dimension of the object in the local area model as a ratio of the dimension (e.g., height, width) of the object in the image including the object to a product of a corresponding dimension (e.g., height, width) of the imaging device 130 that captured the image and a corresponding element of the imaging device projection transform. In the preceding example, the headset 100 determines a width and a height of the object to determine the size of the object in the local area model, allowing a representation of the object in the local area model to reflect dimensions of the object in the local area.

In response to determining 325 the position of the object in the local area model, the headset 100 stores data identifying the object and the position of the object in the local area model. In some embodiments, the data identifying the object comprises one or more labels determined for the object, such as a category of the object or an instance of the object. In other embodiments, the data identifying the object is an object identified. For example, the headset 100 stores coordinates in the local area model determined 325 for the object and one or more labels identifying a category or an instance of the object in an object index 225, as further described above in conjunction with FIG. 2. The headset 100 updates previously determined 325 coordinates for the object with recently determined 325 coordinates in the local area model for the object in various embodiments, allowing the headset 100 to maintain a recent position of the object in the local area model. For example, the headset 100 compares a combination of coordinates within the local area model for the object and one or more labels for the object to stored combinations of coordinates within the local area model for objects and one or more labels stored for objects. The headset 100 updates stored coordinate associated with a stored object with determined coordinates for the object in response to the determined position within the local area model for the object being within a threshold distance of the stored coordinates and the object having at least a threshold amount of labels matching labels associated with the stored coordinates (or a threshold amount of data identifying the object matching stored data associated with the stored coordinates). This allows the headset 100 to update stored positions of objects in the local area with recently determined 325 positions of the objects. In various embodiments, the headset 100 stores an object identifier in association with a combination of the position in the local area determined 325 for the object and the one or more labels for the object to simplify updating of a position in the local area model for the object and to simplify subsequent retrieval and identification of a position of an object in the local area model.

With the position of the object in the local area model determined 325, and with the size of the object in the local area model determined in various embodiments, the headset 100 generates 330 an interface element for the object for display by one or more display elements 120 of the headset 100. The interface element has a position in the local area model based on the position of the object in the local area model. For example, a portion of the interface element contacts a portion of a bounding box corresponding to the object in the local area model. As another example, the headset 100 determines an offset between a boundary of the interface element and portion of the bounding box for the object in the local area model and positions a portion of the interface element at the determined offset, causing display of the interface element based on the offset between the boundary of the interface element and the portion of the bounding box of the object. This allows the interface element to be displayed proximate to the object in the local area, so the interface element may more easily display information about the object to the user. For example, the interface element is displayed to the user via a display element 120 in response to the headset 100 receiving one or more inputs from the user.

The interface element displays information identifying the object in some embodiments, such as a label or an identifier of the object specified by the user. In some embodiments, the interface element displays characteristics or other information about the item the headset 100 received from the user. Hence, the interface element allows the headset 100 to display information about the object to the user that is proximate to the object. Determining the position of the object in the local area model allows display of the interface element proximate to the object that is visible to the user in the local area by a display element 120 of the headset 100. Further, generating 330 the interface element based on the position of the object in the local area model allows the headset 100 to update where the interface element is displayed based on a position of the object, so the position of the interface element in the display element 120 changes as the position of the object relative to the headset changes.

Further, in some embodiments, the headset 100 leverages stored information identifying a determined position of the object in the local area model to display information to the user that directs the user to the object. For example, the headset 100 receives an input from the user identifying the object and requesting navigation to the object. Based on information in the input identifying the object, such as a label associated with the object, the headset 100 retrieves a stored position within the local area model of the object. For example, the headset 100 retrieves coordinates in the local area model of the object stored in the object index 225 in association with a label matching the label received in the input or stored in association with an object identifier included in the received input.

The headset 100 determines the position of the headset 100 in the local area, as further described above in conjunction with FIG. 2, and determines a corresponding position of the headset 100 in the local area model. Based on the position of the headset 100 in the local area model and the stored position within the local area model of the object, the headset determines directions from the position of the headset 100 in the local area model to the stored position within the local area model of the object. To direct the user to the object, the headset 100 displays one or more messages including at least a portion of the directions to the stored position within the local area model of the object. For example, the headset 100 displays prompts for the user to move in a particular direction or to face a particular direction via one or more display elements 120 of the headset 100, with the prompts directing movement of the user to reduce a distance between the position of the headset 100 in the local area model and the stored position within the local area model of the object. This allows the headset 100 to leverage a previously determined position of the object in the local area to direct the user wearing the headset 100 to the object, allowing the user to more easily locate the object.

In various embodiments, when determining directions from the position of the headset 100 in the local area model to the stored position within the local area model of the object, the headset 100 accounts for a recency of the stored position of the object within the local area model. For example, the headset 100 stores a confidence value in association with the position within the local area model of the object and maintains a decay factor that reduces the confidence value over time. The decay factor decreases the confidence value as a time between a current time and a time when the position within the local area model of the object was stored increases. In various embodiments, the headset 100 displays a message to the user via one or more display elements 120 in response to the confidence value stored in association with the position within the local area model of the object being less than a threshold confidence value. The message may indicate that the headset 100 has reduced confidence in the stored position of the headset 100 in the local area being a current location of the headset 100 in the local area.

FIG. 4 is an example of a headset 100 determining a position of an object in a local area model of the local area surrounding the headset 100. FIG. 4 shows an example local area 400 surrounding a headset 100. The local area 400 includes object 405, object 410, and object 415 in the example of FIG. 4. However, in other embodiments, the local area 400 includes a different number of objects. Each of the objects is within a field of view of one or more imaging devices 130 of the headset 100 that are positioned to capture images of the local area 400. The local area 400 is visible to a user wearing the headset 100, so FIG. 4 shows the local area 400 from a point of view of a user wearing the headset 100. At least one imaging device 130 of the headset 100 has a point of view of the local area 400 matching the user's point of view of the local area 400, so an imaging device 130 captures an image of the local area 400 including object 405, object 410, and object 415.

As further described above in conjunction with FIGS. 2 and 3, the headset 100 detects one or more objects in the image of the local area 400. In some embodiments, an object detection module 200 included in the headset 100 detects the objects, while in other embodiments, the object detection module 200 is a discrete component communicatively coupled to the headset 100 that receives the image of the local area 400 from an imaging device 130. Application of one or more object detection models 205 to the image of the local area 400 detects object 405, object 410, and object 415 in the image of the local area 400.

When detecting object 405, object 410, and object 415, the object detection module 200 determines a bounding box for each detected object. A bounding box for an object specifies a boundary of the region of the image including the object. Hence, a region of the image within the bounding box includes the object and regions of the image outside of the bounding box are not the object. In the example of FIG. 4, bounding box 420 specifies boundaries of object 405, bounding box 425 specifies boundaries of object 410, and bounding box 430 specifies boundaries of object 415. As shown in FIG. 4, different bounding boxes have different dimensions, reflecting different dimensions of corresponding objects.

In addition to detecting objects in an image of the local area 400 and determining a bounding box for each detected object, the headset 100 (e.g., the object detection module 200) determines a local area model 435 from depth information or measurement signals obtained by one or more depth sensors of the headset 100. The depth information identifies distances between the headset 100 and one or more regions of the local area 400, such as portions of objects in the local area 400. Hence, the local area model 435 is a three-dimensional representation of the local area 400. In the example of FIG. 4, the local area model 435 includes candidate regions corresponding to locations of objects in the local area 400, with the candidate regions based on depth information about the local area from the one or more depth sensors. For example, a candidate region corresponds to a region in the local area 400 including having depth information differing from depth information for an adjacent region in the local area 400 by at least a threshold amount. In the example of FIG. 4, the local area model 435 includes candidate region 440, candidate region 445, and candidate region 450 based on the depth information obtained by one or more depth sensors. Each of the candidate regions in FIG. 4 is based on differences between distances from the object to each of object 405, object 410, and object 415 and distances from the headset 100 to other portions of the local area 400. Each candidate region has dimensions determined based on the depth information, so different candidate regions have different dimensions (e.g., length, width) than other candidate regions, as shown in the example of FIG. 4.

For each of one or more objects detected in the image of the local area 400, the headset 100 (e.g., the object detection module 200) determines a position in the local area model 435. As further described above in conjunction with FIGS. 2 and 3, the headset 100 determines a position in the local area model 435 of an object based on a bounding box determined for the object and parameters of the imaging device 130 that captured the image of the local area 400. In the example of FIG. 4, the headset 100 determines the position of the local area model 435 for object 410. For example, the headset 100 receives an input from a user selecting the object 410. In other examples, the headset 100 selects each object detected in the image of the local area 400 and determines a corresponding position of an object in the local area model 435.

As further described above in conjunction with FIGS. 2 and 3, the headset 100 determines the position of object 410 in the local area model 435 based on dimensions of bounding box 425 for object 410. Based on dimensions of bounding box 425, the headset 100 determines a center of bounding box 425. From parameters of the imaging device 130 that captured the image of the local area 400, the headset 100 generates a ray 455 passing through the center of bounding box 425. In various embodiments, the ray 455 is perpendicular to bounding box 425. Accounting for parameters of the imaging device 130 when generating the ray 455 for bounding box 425 generates the ray 455 in a coordinate system of the local area model 435.

From the ray 455, the headset 100 determines a position in the local area model 435 where the ray 455 intersects the local area model 435, which specifies the position in the local area model 435 of object 410. In various embodiments, the headset 100 selects a candidate region within the local area model 435 intersected by the ray 455 as the position within the local area model 435 of object 410. The headset 100 may determine a position of object 410 as a candidate region in the local area model 435 within a threshold distance of a position in the local area model 435 intersected by the ray 455. In the example of FIG. 4, the headset 100 determines ray 455 intersects the local area model 435 within candidate region 445, so the headset 100 determines candidate region 445 is the position within the local area model 435 of object 410. The headset 100 stores the position within the local area model 435 in association with information identifying object 410, allowing subsequent retrieval of the position within the local area model 435 of object 410.

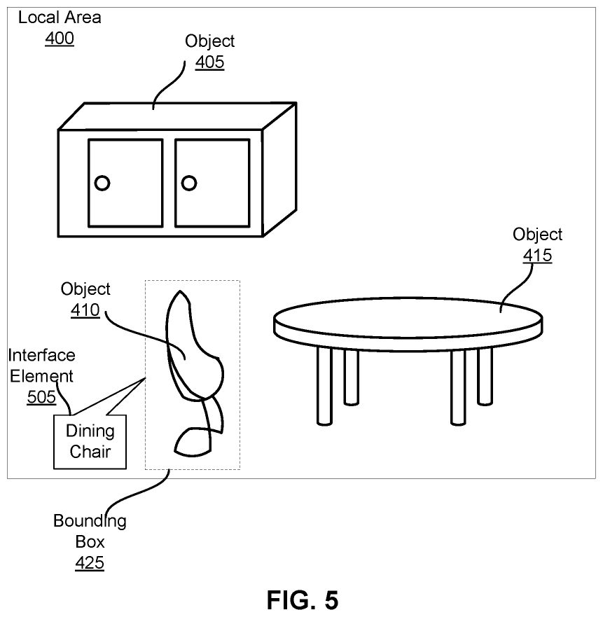

With the position within the local area model 435 determined for object 410, the headset 100 may display one or more interface elements to the user wearing the headset 100 based on the position of object 410 within the local area model 435. Using the position of object 410 within the local area model allows display of one or more interface elements proximate to the object 410 by a display element 120 of the headset 100. FIG. 5 shows an example display of an interface element 505 by a headset 100 proximate to an object in a local area.

As further described above in conjunction with FIG. 4, the local area 400 is visible to a user wearing the headset 100, so FIG. 5 shows the local area 400 from a point of view of a user wearing the headset 100. In the example shown by FIG. 5, the user views object 405, object 410, and object 415 in the local area 400 through the headset 100. For example, the headset 100 includes display elements 120 that are transparent or translucent, allowing the user to view the local area 400 while wearing the headset 100.

As further described above in conjunction with FIGS. 2-4, the headset 100 determines a local area model that is a three-dimensional representation of the local area 400 surrounding the headset 100. Additionally, the headset 100 determines positions of one or more objects in the local area model based on images of the local area and depth information of the local area, as further described above in conjunction with FIGS. 2-4. The headset 100 leverages positions in the local area model of one or more objects in the local area 400 to determine locations in a display element 120 where one or more interface elements are displayed while the user is viewing the local area 400 via the headset 100. In the example of FIG. 5, interface element 505 is displayed by a display element 120 of the headset 100 while a user views the local area 400 through the headset 100. The headset 100 positions interface element 505 based on the position of object 410 in the local area model so interface element 505 is proximate to object 410 when displayed to the user. For example, interface element 505 includes information about object 410 (e.g., an identifier of object 410, characteristics of object 410 provided by the user, etc.), so displaying interface element 505 proximate to object 410 allows the user to easily determine information about object 410. In the example of FIG. 5, interface element 505 is positioned in the local area model of the local area 400 so a portion of interface element 505 contacts a portion of bounding box 425, which specifies a boundary of object 410. As further described above in conjunction with FIGS. 2-4, bounding box 425 is determined by the headset 100 when detecting object 410 in one or more images of the local area 400. Alternatively, interface element 505 is positioned in the local area model relative to a position of object 410 in the local area model. For example, a portion of interface element 505 has a position in the local are model has a specific offset from a portion of bounding box 425 for object 410 in the local area model, so a location where interface element 505 is displayed is determined from a position of the object 410 in the local area model. Positioning interface element 505 in the local area model based on the position of object 410 in the local area model allows interface element 505 to remain in a specific position relative to object 410, allowing repositioning of interface element 505 as a position of object 410 changes.

FIG. 6 is a system 600 that includes a headset 605, in accordance with one or more embodiments. In some embodiments, the headset 605 may be the headset 100 of FIG. 1A or the headset 105 of FIG. 1B. The system 600 may operate in an artificial reality environment (e.g., a virtual reality environment, an augmented reality environment, a mixed reality environment, or some combination thereof). The system 600 shown by FIG. 6 includes the headset 605, an input/output (I/O) interface 610 that is coupled to a console 615, the network 620, and the mapping server 625. While FIG. 6 shows an example system 600 including one headset 605 and one I/O interface 610, in other embodiments any number of these components may be included in the system 600. For example, there may be multiple headsets each having an associated I/O interface 610, with each headset and I/O interface 610 communicating with the console 615. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the console 615 may be provided by the headset 605.

The headset 605 includes the display assembly 630, an optics block 635, one or more position sensors 640, and the DCA 645. Some embodiments of headset 605 have different components than those described in conjunction with FIG. 6. Additionally, the functionality provided by various components described in conjunction with FIG. 6 may be differently distributed among the components of the headset 605 in other embodiments, or be captured in separate assemblies remote from the headset 605.

The display assembly 630 displays content to the user in accordance with data received from the console 615. The display assembly 630 displays the content using one or more display elements (e.g., the display elements 120). A display element may be, e.g., an electronic display. In various embodiments, the display assembly 630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 635.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUs, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The DCA 645 generates depth information for a portion of the local area. The DCA includes one or more imaging devices and a DCA controller. The DCA 645 may also include an illuminator. Operation and structure of the DCA 645 is described above with regard to FIG. 1A. In various embodiments, the DCA 645 includes an object detection module 200, as further described above in conjunction with FIGS. 2-5 that detects an object in a local area surrounding the headset 605 and determines a position of an object in a local area model providing a three-dimensional representation of the local area to the headset 605 based on the depth information generated by the DCA 645. In various embodiments, the position of the object in the local area model determines a position in the local area model of an interface element displayed to a user by the display assembly 630.

The audio system 650 provides audio content to a user of the headset 605. The audio system 650 may comprise one or acoustic sensors, one or more transducers, and an audio controller. The audio system 650 may provide spatialized audio content to the user. In some embodiments, the audio system 650 may request acoustic parameters from the mapping server 625 over the network 620. The acoustic parameters describe one or more acoustic properties (e.g., room impulse response, a reverberation time, a reverberation level, etc.) of the local area. The audio system 650 may provide information describing at least a portion of the local area from e.g., the DCA 645 and/or location information for the headset 605 from the position sensor 640. The audio system 650 may generate one or more sound filters using one or more of the acoustic parameters received from the mapping server 625 and use the sound filters to provide audio content to the user.

The I/O interface 610 is a device that allows a user to send action requests and receive responses from the console 615. An action request is a request to perform a particular action. For example, an action request may be an instruction to start or end capture of image or video data, or an instruction to perform a particular action within an application. The I/O interface 610 may include one or more input devices. Example input devices include: a keyboard, a mouse, a game controller, or any other suitable device for receiving action requests and communicating the action requests to the console 615. An action request received by the I/O interface 610 is communicated to the console 615, which performs an action corresponding to the action request. In some embodiments, the I/O interface 610 includes an IMU that captures calibration data indicating an estimated position of the I/O interface 610 relative to an initial position of the I/O interface 610. In some embodiments, the I/O interface 610 may provide haptic feedback to the user in accordance with instructions received from the console 615. For example, haptic feedback is provided when an action request is received, or the console 615 communicates instructions to the I/O interface 610 causing the I/O interface 610 to generate haptic feedback when the console 615 performs an action.

The console 615 provides content to the headset 605 for processing in accordance with information received from one or more of: the DCA 645, the headset 605, and the I/O interface 610. In the example shown in FIG. 6, the console 615 includes an application store 655, a tracking module 660, and an engine 665. Some embodiments of the console 615 have different modules or components than those described in conjunction with FIG. 6. Similarly, the functions further described below may be distributed among components of the console 615 in a different manner than described in conjunction with FIG. 6. In some embodiments, the functionality discussed herein with respect to the console 615 may be implemented in the headset 605, or a remote system.

The application store 655 stores one or more applications for execution by the console 615. An application is a group of instructions, that when executed by a processor, generates content for presentation to the user. Content generated by an application may be in response to inputs received from the user via movement of the headset 605 or the I/O interface 610. Examples of applications include: gaming applications, conferencing applications, video playback applications, or other suitable applications.

The tracking module 660 tracks movements of the headset 605 or of the I/O interface 610 using information from the DCA 645, the one or more position sensors 640, or some combination thereof. For example, the tracking module 660 determines a position of a reference point of the headset 605 in a mapping of a local area based on information from the headset 605. The tracking module 660 may also determine positions of an object or virtual object. Additionally, in some embodiments, the tracking module 660 may use portions of data indicating a position of the headset 605 from the position sensor 640 as well as representations of the local area from the DCA 645 to predict a future location of the headset 605. The tracking module 660 provides the estimated or predicted future position of the headset 605 or the I/O interface 610 to the engine 665.

The engine 665 executes applications and receives position information, acceleration information, velocity information, predicted future positions, or some combination thereof, of the headset 605 from the tracking module 660. Based on the received information, the engine 665 determines content to provide to the headset 605 for presentation to the user. For example, if the received information indicates that the user has looked to the left, the engine 665 generates content for the headset 605 that mirrors the user's movement in a virtual local area or in a local area augmenting the local area with additional content. Additionally, the engine 665 performs an action within an application executing on the console 615 in response to an action request received from the I/O interface 610 and provides feedback to the user that the action was performed. The provided feedback may be visual or audible feedback via the headset 605 or haptic feedback via the I/O interface 610.

The network 620 couples the headset 605 and/or the console 615 to the mapping server 625. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g., Portable Network Graphics (PNG), hypertext markup language (HTML), extensible markup language (XML), etc.). In addition, all or some of links can be encrypted using conventional encryption technologies such as secure sockets layer (SSL), transport layer security (TLS), virtual private networks (VPNs), Internet Protocol security (IPsec), etc.

The mapping server 625 may include a database that stores a virtual model describing a plurality of spaces, wherein one location in the virtual model corresponds to a current configuration of a local area of the headset 605. The mapping server 625 receives, from the headset 605 via the network 620, information describing at least a portion of the local area and/or location information for the local area. The user may adjust privacy settings to allow or prevent the headset 605 from transmitting information to the mapping server 625. The mapping server 625 determines, based on the received information and/or location information, a location in the virtual model that is associated with the local area of the headset 605. The mapping server 625 determines (e.g., retrieves) one or more acoustic parameters associated with the local area, based in part on the determined location in the virtual model and any acoustic parameters associated with the determined location. The mapping server 625 may transmit the location of the local area and any values of acoustic parameters associated with the local area to the headset 605.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### ADDITIONAL CONFIGURATION INFORMATION

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
capturing, at a headset worn by a user, one or more images of a local area surrounding the headset by one or more imaging devices included in the headset;
detecting an object in the local area from an image of the local are captured by an imaging device;
determining a bounding box for the object, the bounding box specifying dimensions of a region of the image including the object;
determining a local area model of the local are from depth information generated by one or more depth sensors included in the headset, the local area model comprising a three-dimensional reconstruction of the local area;
determining a position of the object in the local area model based on the bounding box for the object and one or more parameters of the imaging device; and
storing the position of the object in the local area in association with information identifying the object.

2. The method of claim 1, wherein determining the position of the object in the local area model based on the bounding box for the object and one or more parameters of the imaging device comprises:
determining a center of the bounding box based on dimensions of the bounding box;
generating a ray intersecting the center of the bounding box in coordinates of the local area model based on parameters of the imaging device; and
determining the position of the object in the local area model as a position in the local area model that the ray intersects.

3. The method of claim 2, wherein the local area model includes one or more candidate regions, each candidate region having depth information differing from adjacent depth information by at least a threshold amount, and determining the position of the object in the local area model as the position in the local area model that the ray intersects comprises:
determining the position of the object in the local area model as a candidate region of the local area model intersected by the ray.

4. The method of claim 2, wherein the local area model includes one or more candidate regions, each candidate region having depth information differing from adjacent depth information by at least a threshold amount, and determining the position of the object in the local area model as the position in the local area model that the ray intersects comprises:
determining the position of the object in the local area model as a candidate region of the local area model within a threshold distance in the local area of a position in the local area model intersected by the ray.

5. The method of claim 1, wherein storing the position of the object in the local area in association with information identifying the object comprises:
storing the position of the object in the local area in association with one or more labels from detection of the object.

6. The method of claim 5, further comprising:
receiving an input at the headset from the user identifying the object and requesting navigation to the object;
retrieving the stored position of the object in the local area model;
determining a current location of the headset in the local area model from the depth information;
generating directions from the current location of the headset in the local area model to the stored position of the object in the local area model; and
displaying at least a portion of the generated directions to the user via one or more display elements.

7. The method of claim 6, wherein generating directions from the current location of the headset in the local area model to the stored position of the object in the local area model comprises:
retrieving a confidence value stored in association with the stored position of the object in the local area model, the confidence value based on a time when the position of the object in the local area model was stored and a decay factor that decreases the confidence value as a time between a current time and the time; and
displaying a message to the user via the one or more display elements in response to the confidence value having less than a threshold confidence value.

8. The method of claim 1, further comprising:
displaying an interface element to the user via one or more display elements of the headset, the interface element displayed in a position in the local area model relative to the position of the object in the local area model.

9. The method of claim 8, wherein the position in the local area model where the interface element is displayed is determined as an offset from a portion of the bounding box for the object.

10. The method of claim 8, wherein a portion of the interface element contacts a portion of the bounding box for the object in the local area model.

11. A headset comprising:
a frame;
one or more display elements coupled to the frame, each display element configured to generate image light for presentation to a user;
one or more imaging devices coupled to the frame, the one or more imaging devices configured to capture images of a local area surrounding the frame;
a depth camera assembly configured to obtain depth information between the headset and portions of the local area; and
an object detection module including a processor and a non-transitory computer readable storage medium having instructions encoded thereon that, when executed by the processor, cause the headset to:
detect an object in the local area from an image of the local are captured by an imaging device;
determine a bounding box for the object, the bounding box specifying dimensions of a region of the image including the object;
determine a local area model of the local area from the depth information, the local area model comprising a three-dimensional reconstruction of the local area;
determine a position of the object in the local area model based on the bounding box for the object and one or more parameters of the imaging device; and
store the position of the object in the local area in association with information identifying the object.

12. The headset of claim 11, wherein determine the position of the object in the local area model based on the bounding box for the object and one or more parameters of the imaging device comprises:
determine a center of the bounding box based on dimensions of the bounding box;
generate a ray intersecting the center of the bounding box in coordinates of the local area model based on parameters of the imaging device; and
determine the position of the object in the local area model as a position in the local area model that the ray intersects.

13. The headset of claim 12, wherein the local area model includes one or more candidate regions, each candidate region having depth information differing from adjacent depth information by at least a threshold amount, and determine the position of the object in the local area model as the position in the local area model that the ray intersects comprises:
determine the position of the object in the local area model as a candidate region of the local area model intersected by the ray.

14. The headset of claim 12, wherein the local area model includes one or more candidate regions, each candidate region having depth information differing from adjacent depth information by at least a threshold amount, and determine the position of the object in the local area model as the position in the local area model that the ray intersects comprises:
determine the position of the object in the local area model as a candidate region of the local area model within a threshold distance in the local area of a position in the local area model intersected by the ray.

15. The headset of claim 11, wherein store the position of the object in the local area in association with information identifying the object comprises:
store the position of the object in the local area in association with one or more labels from detection of the object.

16. The headset of claim 11, wherein the non-transitory computer readable storage medium further has instructions encoded thereon that, when executed by the processor, cause the headset to:
receive an input at the headset from the user identifying the object and requesting navigation to the object;
retrieve the stored position of the object in the local area model;
determine a current location of the headset in the local area model from the depth information;
generate directions from the current location of the headset in the local area model to the stored position of the object in the local area model; and
display at least a portion of the generated directions to the user via one or more display elements.

17. The headset of claim 16, wherein generate directions from the current location of the headset in the local area model to the stored position of the object in the local area model comprises:
retrieve a confidence value stored in association with the stored position of the object in the local area model, the confidence value based on a time when the position of the object in the local area model was stored and a decay factor that decreases the confidence value as a time between a current time and the time; and
display a message to the user via the one or more display elements in response to the confidence value having less than a threshold confidence value.

18. The headset of claim 11, wherein the non-transitory computer readable storage medium further has instructions encoded thereon that, when executed by the processor, cause the headset to:
display an interface element to the user via one or more display elements of the headset, the interface element displayed in a position in the local area model relative to the position of the object in the local area model.

19. The headset of claim 18, wherein the position in the local area model where the interface element is displayed is determined as an offset from a portion of the bounding box for the object.

20. The headset of claim 18, wherein a portion of the interface element contacts a portion of the bounding box for the object in the local area model.
